(19) United States
(12) Patent Application Publication
(10) Pub. No.: US 2018/0032510 A1
(43) Pub. Date: Feb. 1, 2018

(54) AUTOMATED TRANSLATION OF SOURCE CODE

(71) Applicant: Amazon Technologies, Inc., Seattle, WA (US)

(72) Inventors: Mihir Sathe, Seattle, WA (US); Paul Andrew Lafranchise, Seattle, WA (US); Joseph Barry Guglielmo, Seattle, WA (US)

(21) Appl. No.: 14/671,864

(22) Filed: Mar. 27, 2015

(51) Int. Cl. G06F 17/28

(52) U.S. Cl. CPC G06F 17/289

(57) ABSTRACT

In some cases, a localization service may identify candidate strings in the source code of an application. Further, the localization service may determine whether the candidate strings are displayed literals in a first human-perceivable language. In addition, the localization service may replace the identified displayed literals with identification tokens to generate pivot source code. In some examples, an identification token may include a JavaScript function that returns a translation of a displayed literal in a second human-perceivable language or any other desired human-perceivable language. Further, the localization service may verify pivot source code by comparing a localized application corresponding to the pivot source code to the application with the original source code of the application.

### BACKGROUND

As modern businesses continue to expand globally, business operators often develop multilingual web applications to present information in different languages to web visitors. Traditionally, a web application is developed in a first language, and subsequently manually translated into other languages by human agents in order to preserve the functionality of the web application. However, manual translation is inefficient and cumbersome, especially in view of the increasing size and global accessibility of modern web applications.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a pictorial flow diagram showing an illustrative process to generate pivot source code.

FIG. 2 is a block diagram of an illustrative computing architecture of an example localization service device.

FIG. 3 an example user interface for presenting string candidates to a human agent.

FIG. 4 is an example interface for presenting information for verifying a localized application.

FIG. 5 is a flow diagram showing an illustrative process to generate pivot source code.

### DETAILED DESCRIPTION

This disclosure is generally directed to automated localization of software code for presentation in human-perceivable languages different than a human-perceivable language used to write the code and compile the code. Unless otherwise noted, “language” is used herein to mean a human-perceivable spoken language as opposed to a computer programming language. Thus, source code may be written in English and then later translated in part to display French to end users, while the source code retains English commands read by a compiler, for example.

To illustrate, a software developer may develop an application that presents information in a first human-perceivable language for a first locale. The present disclosure describes a localization system that processes source code for the application in the first human-perceivable language, and generates translations in other human-perceivable languages for some of the source code that is user facing, but not for other portions that relate to back-end processing. For instance, a localization system of the present disclosure may identify a string candidate in the source code file of the application. Further, the localization system may classify the string candidate as a displayed literal that is to be output to end users of the software. In addition, the localization system may generate an identification token associated with the displayed literal. The localization system may generate a pivot source code file with the displayed literal replaced by the identification token. In some examples, the identification token may include a function that retrieves a translation of the displayed literal from the first human-perceivable language to a second human-perceivable language. Accordingly, the localization system can use the pivot source code file to display the application in the second human-perceivable language, while retaining source code written in the first human-perceivable language.

In some examples, a source code file of the application may include hypertext markup language (HTML), cascading style sheets, and JavaScript. Further, displayed literals may include alphanumeric text or other symbols displayed in a human-perceivable language during execution of the source code file of the application.

In some embodiments, the localization system may display a string candidate, and a portion of the original source code file associated with the string candidate in a graphical user interface. Further, the localization system may receive an indication that the string candidate includes alphanumeric text or other symbols that are displayed to end users during execution of the original source code file. As a result, the localization system may classify the string candidate as a displayed literal.

In some examples, the localization system may generate a machine classification engine for classifying string candidates as displayed literals based at least in part on a plurality of string candidates previously identified as displayed literals. Further, the localization system may classify a string candidate as a displayed literal based at least in part on the machine classification engine.

In some embodiments, the localization system may display a translation of an application based at least in part on a pivot source code file. Further, the localization system may receive an indication that the localized application based on the pivot source code file matches the display and function of the original source code file of the application.

The techniques and systems described herein may be implemented in a number of ways. Example implementations are provided below with reference to the following figures.

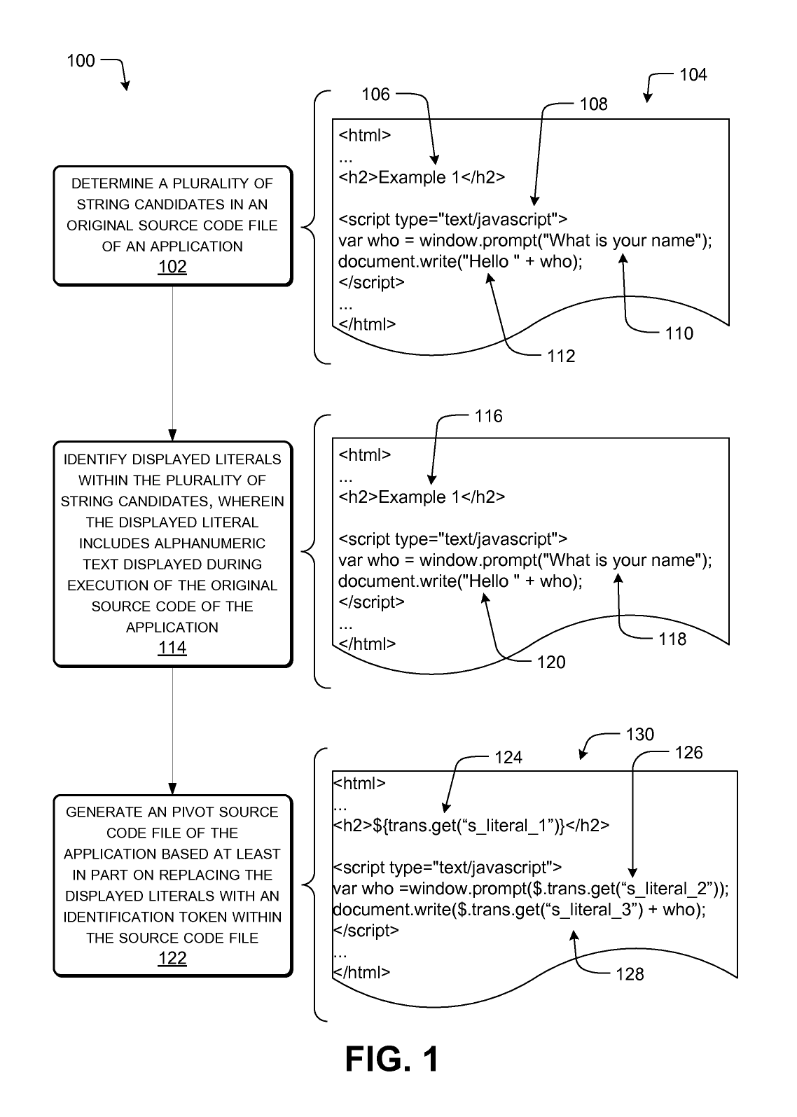

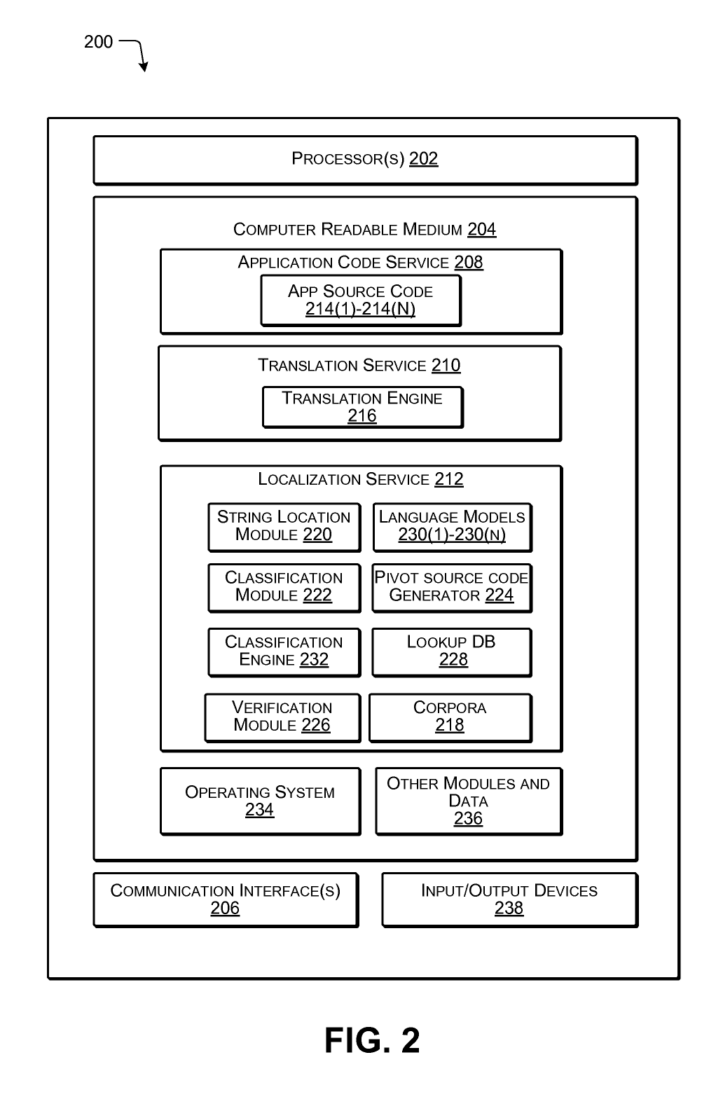

FIG. 1 is a pictorial flow diagram showing an illustrative process 100 to generate pivot source code from an original source code file of an application. The process 100 may be executed, at least in part, by an electronic device, such as the electronic device discussed below with reference to FIG. 2. The process 100 is illustrated as a collection of blocks in a logical flow graph, which represent a sequence of operations that can be implemented in hardware, software, or a combination thereof Adjacent to the collection of blocks is a set of images to illustrate corresponding example actions. In the context of software, the blocks represent computer-executable instructions stored on one or more computer-readable media that, when executed by one or more processing units (such as hardware microprocessors), perform the recited operations. Computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process, or skipped or omitted.

At 102, the localization system may determine a plurality of string candidates located in an original source code file 104 of an application. For example, a localization system may locate a first string candidate 106, a second string candidate 108, a third string candidate 110, and a fourth string candidate 112 in the source code file 104 of an application. However, more or fewer string candidates may be located via this operation.

At 114, the localization system may identify displayed literals within the plurality of string candidates 106-112. A displayed literal may include text, symbols and/or numbers that are displayed to end users during execution of the original source code file 104 of the application. For example, the localization system may classify the first string candidate 106, the third string candidate 110, and the fourth string candidate 112 as a first displayed literal 116, a second displayed literal 118, and a third displayed literal 120, respectively. In one example, the localization system may classify the first string candidate 106, the third string candidate 110, and the fourth string candidate 112 as displayed literals based at least in part on a machine-learning engine used to identify and/or label text as displayed literals. Further, the machine-learning engine may be trained using string candidates previously classified as displayed literals. In another example, the localization system may display, to a human agent, a portion of the source code file 104 that includes the first string candidate 106, the third string candidate 110, and the fourth string candidate 112 (and possibly other portions of text and/or symbols), and ask a human agent to classify the text and/or symbols as being a displayed literal or not being a displayed literal. Thus, the localization system may receive an indication from the human agent that the first string candidate 106, the third string candidate 110, and the fourth string candidate 112 are displayed literals.

At 122, the localization system may generate a pivot source code file of the application based at least in part on replacing the displayed literals with identification tokens within the source code file. For example, the localization system may generate a first identification token 124, a second identification token 126, and a third identification token 128. In some examples, the first identification token 124, the second identification token 126, and the third identification token 128 may individually correspond to one of the first displayed literal 116, the second displayed literal 118, and the third displayed literal 120. Further, the localization system may replace the first displayed literal 116, the second displayed literal 118, and the third displayed literal 120 with their corresponding identification token within the source code file 104 to generate intermediary or pivot source code file 130. In some examples, individual identification tokens may include a function that returns a displayed literal in a specified language. For example, the first identification token 124 may return the first displayed literal 116 in a specified language when the source code 104 of the code is executed. Thus, the pivot source code file 130 will display the first displayed literal 116, the second displayed literal 118, and the third displayed literal 120 in the specified language when the pivot source code file 130 is executed within an application, such as within a web browser.

In some examples, the identification token may include a JavaScript function, a Java Server Pages function, an Active Server Pages function, a Hypertext Preprocessor (“PHP”) function, or any other server side template function. For instance, if the source code file includes HTML, the localization system may replace a displayed literal with a Java Server Pages function. In another instance, if the source code file includes JavaScript, the localization system may replace a displayed literal with a JavaScript function.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

FIG. 2 is a block diagram of an illustrative computing architecture 200 of an example localization service computing device. The computing architecture 200 may include one or more computing devices that may be embodied in any number of ways. Further, while the figures illustrate the components and data of the computing architecture 200 as being present in a single location, these components and data may alternatively be distributed across different computing devices and different locations in any manner. Consequently, the functions may be implemented by one or more computing devices, with the various functionality described herein distributed in various ways across the different computing devices. Multiple service computing devices may be located together or separately, and organized, for example, as virtual servers, server banks and/or server farms. The described functionality may be provided by the servers of a single entity or enterprise, or may be provided by servers and/or services of multiple different entities or enterprises. For instance, in the case of the modules, other functional components, and data may be implemented on a server, a cluster of servers, a server farm or data center, a cloud-hosted computing service, a cloud-hosted storage service, and so forth, although other computer architectures may additionally or alternatively be used.

In the illustrated example, the computing architecture 200 may include one or more processors 202, one or more computer-readable media 204, and one or more communication interfaces 206. Each processor 202 may be a single processing unit or a number of processing units, and may include single or multiple computing units or processing cores. The processor(s) 202 can be implemented as one or more microprocessors, microcomputers, microcontrollers, digital signal processors, central processing units, state machines, logic circuitries, and/or any devices that manipulate signals based on operational instructions. For instance, the processor(s) 202 may be one or more hardware processors and/or logic circuits of any suitable type specifically programmed or configured to execute the algorithms and processes described herein. The processor(s) 202 can be configured to fetch and execute computer-readable instructions stored in the computer-readable media 204, which can program the processor(s) 202 to perform the functions described herein.

The computer-readable media 204 may include volatile and nonvolatile memory and/or removable and non-removable media implemented in any type of technology for storage of information, such as computer-readable instructions, data structures, program modules, or other data. Such computer-readable media 204 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing architecture 200, the computer-readable media 204 may be any type of computer-readable storage media and/or may be any tangible non-transitory media to the extent that non-transitory computer-readable media exclude media such as energy, carrier signals, electromagnetic waves, and signals per se.

The computer-readable media 204 may be used to store any number of functional components that are executable by the processors 202. In many implementations, these functional components comprise instructions or programs that are executable by the processors 202 and that, when executed, specifically configure the one or more processors 202 to perform the actions attributed herein to the computing architecture 200. In addition, the computer-readable media 204 may store data used for performing the operations described herein.

In the illustrated example, the functional components stored in the computer-readable media 204 may include an application code service 208, a translation service 210, and a localization service 212. The application code service 208 may store, organize, and manage application data for one or more applications. For instance, the application code service 208 may include source code 214, images, videos, and audio content for a plurality of applications. Further, each source code 214 may include a collection of computer instructions for compiling a particular application. In some examples, the source code 214 may be written in one or more programming languages (e.g., JavaScript, Hypertext markup Language (“HTML”), Java™, Python™, Ruby, C, C++, C#™, Groovy, Scala, etc.)

As described herein, an “application” may be configured to execute a single task or multiple tasks. The application may be a web application, a standalone application, a widget, or any other type of application or “app”. In some embodiments, the application may be configured to be executed by a browser. For example, the application may include software applications that are written in a scripting language that can be accessed via web browser. In some instances, applications can include HTML code which downloads additional code (e.g., JavaScript code), which operates on a web browser's Document Object Model.

The translation service 210 may translate textual content from a first human-perceivable language to one or more other human-perceivable languages. For example, the translation service 210 may receive, from a client service, a translation request that includes textual content. In some examples, the translation request may specify the first human-perceivable language corresponding to the textual content and/or the second human-perceivable language. In some other examples, the translation service 210 may determine the first human-perceivable language based in part on the textual content. Further, the translation service 210 may determine the first human-perceivable language and/or second human-perceivable language based at least in part on information associated with the client service (e.g., geographic information).

In response to receipt of the request, the translation service 210 may translate the textual content from the first human-perceivable language to the second human-perceivable language using a machine translation engine 216. Further, the translation service 210 may send a response message including the translation result to the client service. In some examples, the machine translation engine 216 may incorporate one or more statistical translation models. The statistical translation models may include word-based translation models, phrase-based translation models, syntax-based translation models, and hierarchical phrase-based translation models. In addition, the translation service 210 may periodically update and re-generate the statistical models based on new training data to keep the statistical models up to date.

The localization service 212 may process the source code 214 for an application in a first human-perceivable language, and generate localized versions of the application in other human-perceivable languages. In some examples, the localization service 212 may process source code 214 included in the application code service 208. For instance, the localization service 212 may receive a request from a human agent to generate a pivot source code file for source code 214 and/or a request to generate a localized version of source code 214. In some examples, the request may specify the target locale and/or target human-perceivable language. In some other examples, the localization service 212 may determine the target locale and/or target human-perceivable language based at least in part on geographic information associated with the source of the request.

Further, as described herein, information associated with the generation of the localized versions of the application may be stored as corpora 218. In some examples, the corpora 218 may include machine-readable texts representative of source code in the source code 214. Further, the contents of the corpora may include tags that identify string candidates classified as displayed literals. As further described herein, the tags of the corpora 218 may correspond to string candidates previously classified as displayed literals by the localization service 212.

The localization service 212 may include a string location module 220, a classification module 222, a pivot source code generator 224, and a verification module 226. The string location module 220 may identify a plurality of string candidates in source code 214 associated with an application. For instance, the string location module 220 may parse the source code 214 of the application and determine string content included in the source code 214. As used herein, “string content” may include a sequence of characters either as a literal constant or a programming variable included in a source code file 214.

In some examples, the string location module 220 may identify string candidates based at least in part on one or more programming language models 230(1)-(N) associated with the source code 214. In some examples, a language model 230 may include language specific information related to syntax and/or a coding standard associated with the particular programming language. For instance, the string location module 220 may determine the candidate strings in the source code 214 based at least in part on a first language model associated with HTML and second language model associated with JavaScript. As an example, the first language model associated with HTML may instruct the string location module 220 to identify content as a string candidate when the content is located between angle signs of HTML tags (e.g., > . . . <), located between single quotes (e.g., ‘ . . . ’), located between double quotes (e.g., “ . . . ”), and located between escaped double quotes (e.g., \“ . . . \”, &quot; &quot, etc). As another example, the second language model associated with JavaScript may instruct the string location module 220 to identify content as a string candidate when the content is located between single quotes (e.g., ‘ . . . ’), located between double quotes (e.g., “ . . . ”), and a string escaped using an escaped character of JavaScript (e.g., \“ . . . \”, \‘ . . . \’, etc.). Given that the language models and associated rules do not identify string candidates based on grammar rules, the localization service can be used to translate any human-perceivable language.

The classification module 222 may determine whether a string candidate is a displayed literal. For instance, the classification module 222 may determine that a string candidate is a displayed literal based at least in part on determining that the string candidate is alphanumeric text and/or symbols displayed to end users during execution of the source code 214 of the application, such as by a web browser.

In some examples, the classification module 222 may display a string candidate and a portion of the source code 214 that includes the string candidate on a graphical user interface. Further, the classification module 222 may receive an indication from a human agent whether or not the string candidate is a displayed literal.

In some other examples, the classification module 222 may determine that the string candidate is alphanumeric text and/or symbols displayed to end users during execution of the source code 214 based at least in part on a machine classification engine 232. Further, the machine classification engine 232 may be trained to identify displayed literals based at least in part on the corpora 218.

In various embodiments, the localization service 212 may partition the source code files 214 of the application into a plurality of portions. Further, the localization service 212 may process the different portions sequentially or in parallel. In some examples, the localization service 212 may process a first portion of the source code 214. Further, the localization service may store classification results associated with the first portion to the corpora 218. Further, the localization service may generate a machine classification engine based at least in part on the classification results associated with the first portion. Thus, the classification module 222 may determine that a string candidate of a second portion of the source code 214 is a displayed literal based at least in part on machine-learning associated with the first portion of the source code 214.

The pivot source code generator 224 may generate pivot source code files for an application. Once the classification module 222 determines that a string candidate is a displayed literal, the pivot source code generator 224 may retrieve or generate a string identifier for the displayed literal. Further, the pivot source code generator 224 may store an association between the displayed literal and the string identifier in a lookup database 228. The lookup database may include a relational database, NoSQL database, a text file, a spreadsheet or other electronic list.

In addition, the pivot source code generator 224 may retrieve or generate an identification token associated with the displayed literal. In some examples, the identification token may include a function that returns a translation result corresponding to a string identifier. For instance, the function may take a string identifier as a parameter. Further, the function may retrieve the displayed literal associated with string identifier, and send a request to the translation service 210 to translate the displayed literal from a first human-perceivable language to a second human-perceivable language. Lastly, the function may return the translation response received from the translation service 210.

Further, the pivot source code generator 224 may generate pivot source code files of the application based at least in part on replacing the displayed literal with the identification token within the source code files 214. Therefore, when the pivot source code file is executed, the identification token will place a translation of the displayed literal to a second human-perceivable language, or any other requested human-perceivable language, in the place of the displayed literal, thus localizing the source code. In some examples, the pivot source code generator 224 may normalize the source code before substituting the identification token for the displayed literal within the source code in order to reduce the probability of error. For example, the pivot source generator 224 may replace individual single quotes (e.g., ‘ . . . ’) within the source code with double quotes (e.g., “ . . . ”), or replace individual double quotes (e.g., “ . . . ”) within the source code with single quotes. Additionally, the pivot source code generator 224 may replace a plurality of instances of a displayed literal within source code files 214 with the same identification token.

The verification module 226 may verify that the pivot source code files match the source code files 214. For instance, the verification module 226 may determine that the functionality of a localized application corresponding to pivot source code is the same as the functionality of the original application corresponding to the source code 214.

In some examples, the verification module 226 may include a browser layout engine that loads the localized application and presents the localized application in a graphical user interface. Further, the verification module 226 may receive an indication that the localized application matches the original application. For instance, the verification module 226 may present the localized application within a web browser to a human agent, and receive an indication from a human agent with regard to whether or not the functionality of the localized application matches the original application.

In some other examples, the verification module 226 may include a simulation agent capable of simulating user interactions with user interface elements of an application. In some instances, the user interactions can be performed similarly to crawling a web page and can be based on an algorithm. Further, the verification module 226 may compare the results of simulating the user interactions with respect to a localized application to the results of simulating the user interactions with respect to the original application to determine whether or not the localized application matches the original application. In addition, when the verification module 226 determines that the localized application does not match the original application, the verification module 226 may identify one or more portions of the pivot source code that are associated with one or more differences between the localized application and the original application. Further, the verification module may present the identified portions to a human agent.

Additional functional components stored in the computer-readable media 204 may include an operating system 234 for controlling and managing various functions of the computing architecture 200. The computing architecture 200 may also include or maintain other functional components and data, such as other modules and data 236, which may include programs, drivers, etc., and the data used or generated by the functional components. Further, the computing architecture 200 may include many other logical, programmatic and physical components, of which those described above are merely examples that are related to the discussion herein.

The communication interface(s) 206 may include one or more interfaces and hardware components for enabling communication with various other devices. For example, communication interface(s) 206 may facilitate communication through one or more of the Internet, cable networks, cellular networks, wireless networks (e.g., Wi-Fi, cellular) and wired networks. As several examples, the computing architecture 200 may communicate and interact with other devices using any combination of suitable communication and networking protocols, such as Internet protocol (IP), transmission control protocol (TCP), hypertext transfer protocol (HTTP), cellular or radio communication protocols, and so forth.

The computing architecture 200 may further be equipped with various input/output (I/O) devices 238. Such I/O devices 238 may include a display, various user interface controls (e.g., buttons, joystick, keyboard, mouse, touch screen, etc.), audio speakers, connection ports and so forth.

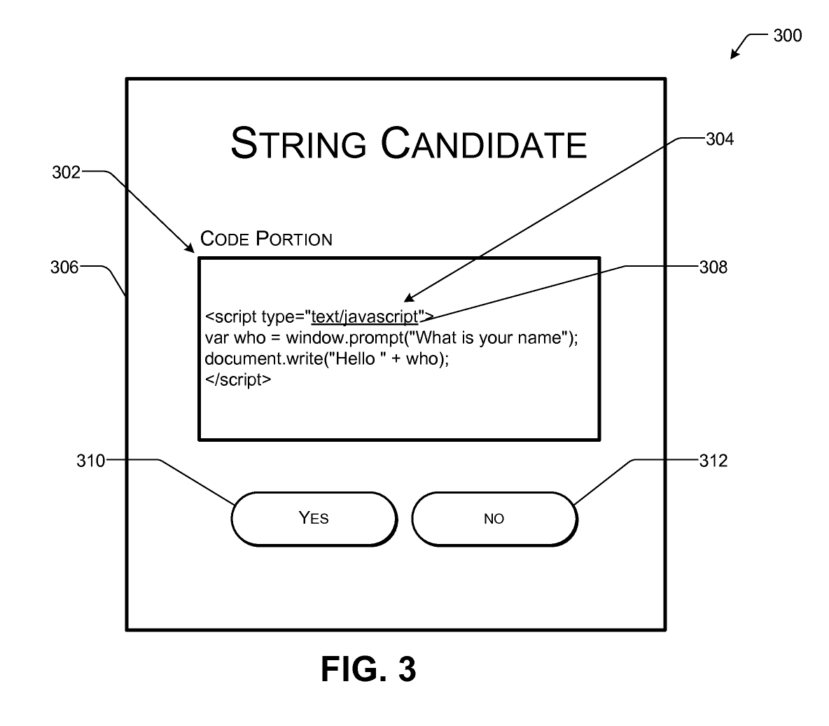

FIG. 3 illustrates an example graphical user interface 300 for presenting string candidates to a human agent according to some implementations. For example, a portion of source code 302, such as the source code 214 discussed above, may include a candidate string 304. The candidate string 304 may be presented on a display 306 to the human agent or may be presented to the human agent using any other suitable communication technology. As described herein, the string location module 220 may identify a string candidate in a source code 214 associated with an application. Further, the classification module 222 may present graphical user interface 300 to the human agent in order to classify the string candidate 304. In the illustrated example, the string candidate may be stylized 308 to help distinguish the string candidate 304 from the portion of the source code 302 including the string candidate 304. Some examples of stylization may include font size, font type, font color, font highlighting, underline, bold, and/or italics.

FIG. 3 further illustrates that the human agent may indicate whether the string candidate 304 is a displayed literal. In the illustrated example, the string candidate 304 is an attribute of an html tag, and thus not a displayed literal. Therefore, the human agent may select the “No” control 312 to indicate that the string candidate 304 does not include a displayed literal. In another instance, the human agent may select the “Yes” control 310 to indicate that the string candidate 304 includes a displayed literal. However, in some embodiments, the designation may be automated and not require human input for each designation of displayed literals. For example, human input may be used for some instances where a confidence level is less than a threshold amount in an analysis of the string candidate 304, via a review process, and/or in other ways. In some examples, the classification module 222 may determine the confidence level based at least in part on the classification engine 232. For instance, the classification engine may determine a probability that the string candidate is a displayed literal.

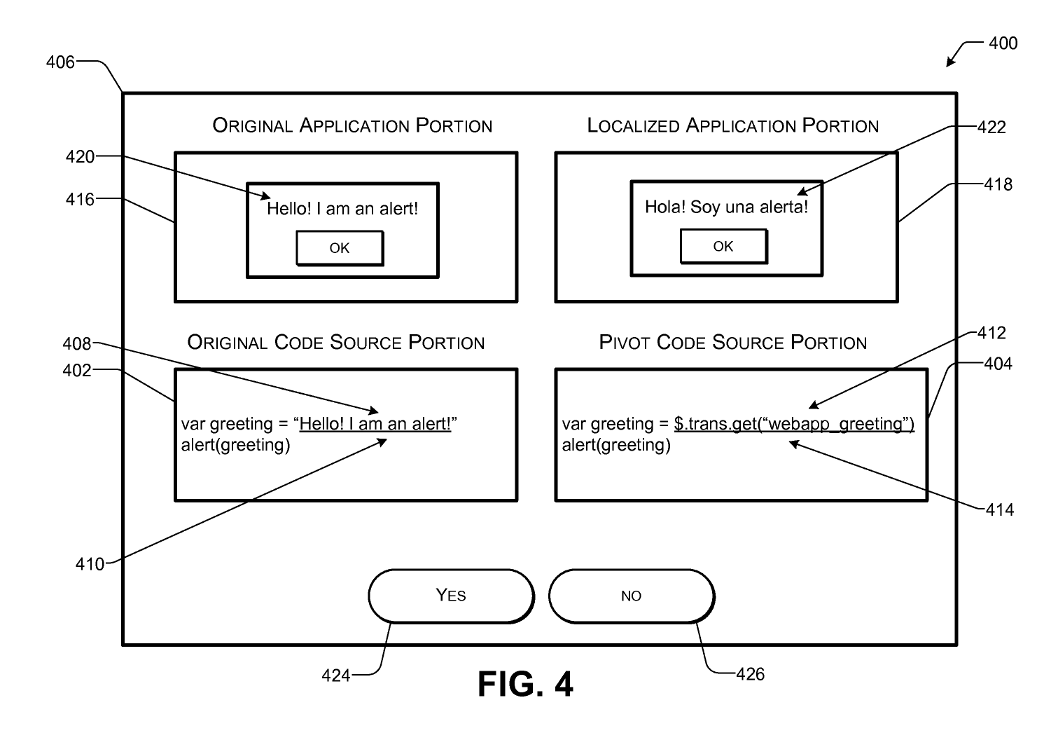

FIG. 4 illustrates an example graphical interface 400 for verifying the functionality of a localized application according to some implementations. For example, source code 402 of an application and pivot source code 404 corresponding to the source code 402 may be presented on a display 406 associated with a human agent or may be presented to a user using any other suitable communication technology. As described above, the localization service 212 (shown in FIG. 2) may generate the pivot source code 404 to create a localized version of the application. In some examples, the localized version of the application may display displayed literals of the application in a different human-perceivable language than displayed in the original version of the application.

In the illustrated example, the original of source code 402 includes a displayed literal 408. Further, the displayed literal 408 may be stylized 410 to help distinguish the displayed literal 408 from the original source code 402. In addition, the pivot source code 404 includes an identification token 412 corresponding to the displayed literal 408. As described herein, the pivot source code generation module 224 (shown in FIG. 2) may replace the displayed literal 408 with the identification token 412 to generate the pivot source code 404. Further, the identification token 412 may be stylized 414 to help distinguish the identification token 412 from the pivot source code 404.

FIG. 4 further illustrates a browser layout engine 416 that has loaded the original source code 402 and a browser layout engine 418 that has loaded the pivot source code 404. In some cases, the human agent may compare a user interface element 420 in the browser layout engine 416 to a user interface element 422 in the browser layout engine 418 to verify that the pivot source code 404 matches the original source code 402. For instance, the human agent may review and/or interact with the user interface element 420 and the user interface element 422 to determine whether the function of the elements is the same and presented/executed as expected.

FIG. 4 further illustrates that the human agent may indicate whether the pivot source code 404 of the localized application matches the original source code 402 of the application. In the illustrated example, the user interface element 422 in the second human-perceivable language matches the user interface element 420 in the first human-perceivable language. Therefore, the human agent may select the “Yes” control 424 to indicate that the user interface element 422 matches the user interface element 420. In another instance, the human agent may select the “No” control 426 to indicate that the user interface element 422 does not match the user interface element 420.

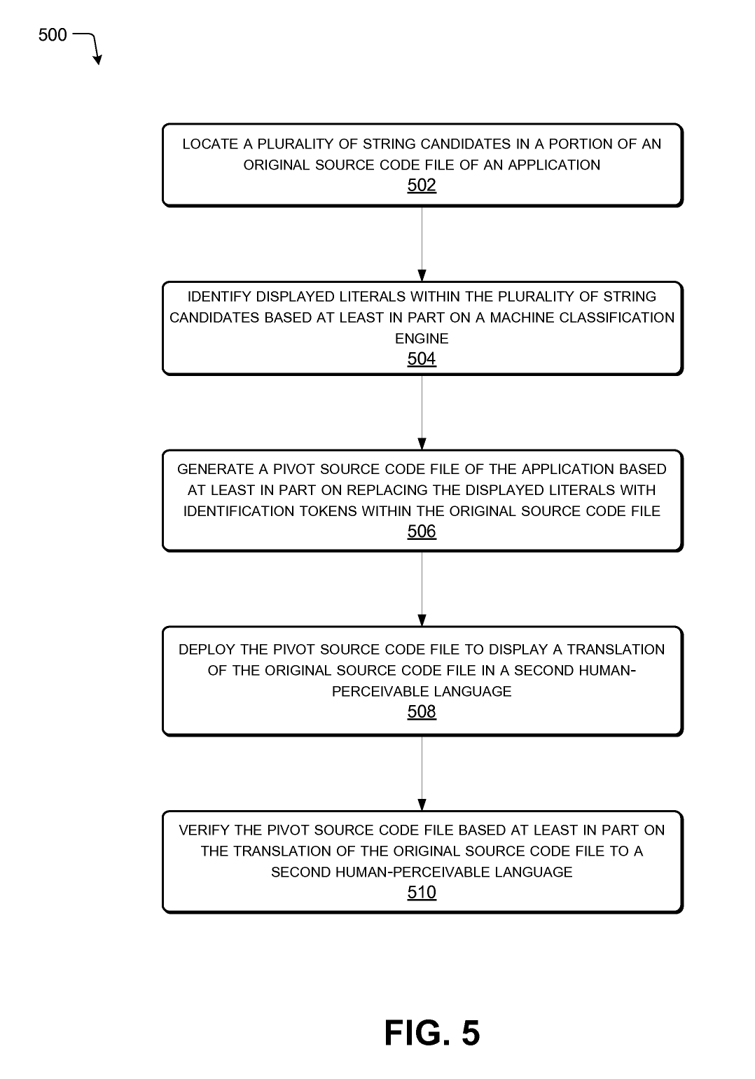

FIG. 5 illustrates a process 500 for generating and verifying a pivot source code file from an original source code file according to some implementations. The process 500 is illustrated as a collection of blocks in a logical flow graph, which represent a sequence of operations that can be implemented in hardware, software, or a combination thereof. The blocks are referenced by numbers 502-510. In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like that perform particular functions or implement particular abstract data types. The order in which the operations is described is not intended to be construed as a limitation, and any number of the described blocks can be combined in any order and/or in parallel to implement the process.

At 502, a localization service may locate a plurality of string candidates in a portion of an original source code file of an application. For instance, the string location module 220 may parse the source code 214 of an application and identify string content included in the source code 214. In some examples, the source code 214 may include JavaScript. Therefore, the string location module 220 may identify content as a string candidate when the content is located between single quotes (e.g., ‘ . . . ’), located between double quotes (e.g., “ . . . ”), and a string escaped using an escaped character of JavaScript (e.g., \“ . . . \”, \‘ . . . \’, etc.). Further, the string location module may identify a string candidate based at least in part on the language model 230 associated with JavaScript. The language model 230 may include rules for identifying string candidates in JavaScript.

At 504, the localization service may identify displayed literals within the plurality of string candidates based at least in part on a machine classification engine. For example, the classification module 222 may determine that one or more of the string candidates are alphanumeric text and/or symbols displayed to end users during execution of the source code 214 based at least in part on a machine classification engine 232. In some instances, the machine classification engine 232 may be trained using the corpora 218. Further, the corpora 218 may include portions of the source code 214 previously processed by the localization service 212.

At 506, the localization service may generate a pivot source code file of the application based at least in part on replacing the displayed literals with identification tokens within the original source code file. For example, the pivot source code generator 224 may retrieve or generate a string identifier for the displayed literal. Further, the pivot source code generator 224 may store an association between the displayed literal and the string identifier in a lookup database 228. In addition, the pivot source code generator 224 may retrieve an identification token associated with the string identifier. Further, the pivot source code generator 224 may replace the displayed literal with the identification token within the source code file 214. For instance, the pivot source code generator 224 may replace individual displayed literals with corresponding JavaScript functions that return the corresponding displayed literals.

At 508, the localization service may deploy the pivot source code file to display a translation of the original source code file in a second human-perceivable language. For example, the pivot source code file may be loaded into a browser layout engine 418. In some other examples, the pivot source code may be deployed to an application server as a localized application.

At 510, the localization service may verify the pivot source code file based at least in part on the translation of the original source code file to a second human-perceivable language. For example, the verification module 226 may present the localized application within a web browser to a human agent, and receive an indication from the human agent with regard to whether or not the functionality of the localized application matches the original application. In another example, the verification module 226 may include a simulation agent capable of simulating user interactions with user interface elements of an application. Further, the verification module 226 may determine whether or not the functionality of the localized application matches the original application based at least in part on the simulated user interactions.

Various instructions, methods and techniques described herein may be considered in the general context of computer-executable instructions, such as program modules stored on computer storage media and executed by the processors herein. Generally, program modules include routines, programs, objects, components, data structures, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

1. A method comprising:
locating a plurality of string candidates in an original source code file of an application;
classifying, based at least in part upon an application of a language model, the plurality of string candidates;
identifying, based at least in part upon the classifying, a displayed literal within the plurality of string candidates, wherein the displayed literal includes text displayed in a first human-perceivable language during execution of the original source code file of the application;
storing, in a database, a mapping between the displayed literal and a string identifier that identifies the displayed literal;
generating an identification token for the displayed literal, wherein the identification token includes the string identifier and a server-side translation function that returns a translation of the displayed literal associated with the identification token;
generating a pivot source code file of the application based at least in part on replacing the displayed literal with the identification token within the original source code file; and
deploying the pivot source code file to display a translation of the original source code file to a second human-perceivable language based at least in part on:
determining the displayed literal based on performing a look-up operation on the database;
determining a translation of the displayed literal to the second human-perceivable language; and
causing display of the translation of the displayed literal in place of the identification token.

2. The method as recited in claim 1, wherein the identifying a displayed literal within the plurality of string candidates further comprises:
generating a machine classification engine for classifying string candidates as displayed literals based at least in part on a plurality of string candidates previously identified as displayed literals, and
wherein identifying a displayed literal within the plurality of string candidates is based at least in part on the machine classification engine.

3. The method as recited in claim 1, wherein the identifying a displayed literal within the plurality of string candidates further comprises:
causing display of a string candidate and a portion of the original source code file associated with the string candidate on a graphical user interface, and
receiving an indication that the string candidate includes alphanumeric text or symbols displayed during execution of the original source code file.

4. The method as recited in claim 1, further comprising:
receiving an indication that the displayed translation of the original source code file matches a display or function of the original source code file of the application.

5. The method as recited in claim 1, wherein the original source code file includes at least one of hypertext markup language, cascading style sheets, or JavaScript.

6. A system comprising:
one or more processors; and
one or more computer-readable media storing instructions executable by the one or more processors, wherein the instructions program the one or more processors to implement a service to:
locate a plurality of string candidates in a portion of an original source code file of an application, wherein the application displays textual content in a first human-perceivable language;
classify, based at least in part upon an application of a language model, the plurality of string candidates;
identify, based at least in part upon classifying the plurality of string candidates, a displayed literal within the plurality of string candidates;
generate an identification token that includes a server-side translation function that returns a translation of the displayed literal; and
generate a pivot source code file of the application based at least in part on replacing the displayed literal with the identification token within the original source code file.

7. The system as recited in claim 6, wherein the instructions further program the one or more processors to deploy the pivot source code file to display a localized version of the application, wherein localized version displays the textual content in a second human-perceivable language.

8. The system as recited in claim 6, wherein the original source code file includes JavaScript, and locating the plurality of string candidates in a portion of an original source code file of an application further comprises at least one of:
identifying escaped string values; or
identifying string values located between quotation marks.

9. The system as recited in claim 6, wherein the original source code file includes hypertext markup language (HTML), and locating the plurality of string candidates in a portion of an original source code file of an application further comprises at least one of:
identifying string values located between HTML tags;
identifying string values located between quotation marks; or
identifying string values located between escaped double quotation marks.

10. The system as recited in claim 6, wherein the instructions further program the one or more processors to:
receive an indication that the pivot source code file matches a function of the original source code file of the application; and
store a portion of the original source code file including the displayed literal as corpora.

11. The system as recited in claim 10, wherein the displayed literal represents a first displayed literal, and the instructions further program the one or more processors to:
generate a machine classification engine for classifying string candidates as displayed literals based at least in part on the corpora; and
identify a second displayed literal within the plurality of string candidates based at least in part on the machine classification engine.

12. The system as recited in claim 6, wherein the identifying a displayed literal within the plurality of string candidates comprises:
replacing individual single quotes within the original source code file with double quotes to normalize the original source code file.

13. The system as recited in claim 6, wherein the identification token includes at least one of a JavaScript function, a Java Server Pages function, or an Active Server pages function.

14. The system as recited in claim 6, wherein the displayed literal includes alphanumeric text or symbols displayed in the first human-perceivable language during execution of the original source code file of the application.

15. One or more non-transitory computer-readable media maintaining instructions that, when executed by one or more processors, program the one or more processors to:
determine a plurality of string candidates in an original source code file of an application;
classify, based at least in part upon an application of a language model, the plurality of string candidates;
identify, based at least in part upon classifying the plurality of string candidates, a displayed literal within the plurality of string candidates;
generate an identification token that includes a server-side translation function that returns a translation of the displayed literal; and
generate a pivot source code file of the application based at least in part on replacing the displayed literal with the identification token within the original source code file.

16. The one or more non-transitory computer-readable media as recited in claim 15, wherein the displayed literal represents a first displayed literal, and the instructions further program the one or more processors to:
generate a machine classification engine for classifying string candidates as displayed literals based at least in part on identification of the first displayed literal; and
identify a second displayed literal within the plurality of string candidates based at least in part on the machine classification engine.

17. The one or more non-transitory computer-readable media as recited in claim 15, wherein the original source code file includes at least one of hypertext markup language (HTML), cascading style sheets, or JavaScript.

18. The one or more non-transitory computer-readable media as recited in claim 15, wherein the identification token includes a JavaScript function.

19. The one or more non-transitory computer-readable media as recited in claim 18, wherein the original source code file is in a first human-perceivable language, and wherein the JavaScript function determines a translation of the displayed literal to a second human-perceivable language and returns the translation of the displayed literal in place of the identification token.

20. The one or more non-transitory computer-readable media as recited in claim 15, wherein the displayed literal includes alphanumeric text or symbols displayed in a human-perceivable language during execution of the original source code file of the application.
